(19) United States
(12) Patent Application Publication
(10) Pub. No.: US 2008/0168209 A1
(43) Pub. Date: Jul. 10, 2008

(54) DATA PROTECTION VIA SOFTWARE CONFIGURATION OF MULTIPLE DISK DRIVES

(75) Inventor: James M. Davison, Tucson, AZ (US)

Correspondence Address: LAW OFFICE OF DAN SHIFRIN, PC - IBM, 14081 WEST 59TH AVENUE, ARVADA, CO, 80004, US

(73) Assignee: IBM CORPORATION, Armonk, NY (US)

(21) Appl. No.: 11/621,494

(22) Filed: Jan. 9, 2007

(51) Int. Cl. G06F 12/02

(52) U.S. Cl. 711/6; 711/114; 711/173; 711/E12.002

(57) ABSTRACT

A data storage system and a method for managing a data storage system are provided. A storage controller is programmed with a disk configuration for each of one or more logical disk arrays and a protection level k. The available storage space from one or more disk drives in the data storage system is merged into a single virtual address space and the merged storage space is divided into storage segments. Next, the storage segments are allocated among the logical disk arrays and a configuration table is generated indicating the number of storage segments in each logical disk array and the physical location of each storage segment on a disk drive. The configuration table is stored in the storage controller and k copies of data may then be stored on the logical disk arrays.

### RELATED APPLICATION DATA

The present application is related to commonly-assigned and co-pending U.S. application Ser. No. 11/______ [IBM Docket #TUC920050155US1], entitled ______, filed on the filing date hereof, which application is incorporated herein by reference in its entirety.

### TECHNICAL FIELD

The present invention relates generally to data storage and, in particular, to the configuration of multiple hard disks through software instructions.

### BACKGROUND ART

Hard disk drives are becoming more powerful in terms of speed and capacity. And, arrays of disk drives, such as RAID (redundant array of independent/inexpensive drives) arrays are becoming more powerful in terms of their ability to protect the stored data. The various levels of RAID are well known in the industry and various new and more complex levels or combinations of levels are being developed to further improve data protection and fault tolerance. However, hard drives do fail and, even though such failures are rare on a percentage basis, due to the huge number of drives in use, the number of drive failures is, in fact, significant. Moreover, in certain critical applications or installations, any failure is significant. Due to the high use of data backups of various kinds, the risk of a loss of data has declined while a major concern has become loss of data availability during the recovery from a failure.

FIG. 1 illustrates a RAID system 100 in which data stored at a primary site 110 is replicated through a peer-to-peer remote copy (PPRC) operation to a secondary site 120. In the system 100 of FIG. 1, the user establishes a fixed, logical relationship between physical storage locations in the primary and secondary storage sites 110, 120.

A RAID controller is programmed with instructions for the RAID level of the array and all drives in the array are dedicated to the array, resulting in a fixed configuration which can support only one RAID level. Moreover, in most installations, all of the drives in the array must be on the same backplane. Thus, a typical RAID system is inflexible. And, the new RAID levels are using increasingly complex RAID algorithms and are requiring more complicated controllers.

Some companies have also developed “software RAID” but such systems merely emulate hardware RAID and retain all of the limitations of hardware RAID, including the predefined, fixed disk arrays and the predefined, single RAID level.

However, it would be preferable if, rather than continue to increase the complexity of algorithms and hardware, existing resources could be used more efficiently and in a more flexible manner.

### SUMMARY OF THE INVENTION

The present invention provides a method for managing a data storage system. A storage controller is programmed with a disk configuration for each of one or more logical disk arrays and the available storage space from one or more disk drives. The sum of all disk arrays and available storage space in the data storage system is merged into a single virtual address space. The virtual address space is divided, splitting the merged storage space into segments. Next, the segments are allocated logically to devices according to storage demands from the user. These logical storage devices are organized using a configuration table indicating the number of storage segments in each device. The configuration table is stored in the storage controller and data may then be stored on the logical disk arrays and the segments are mapped to physical locations by the drive controller.

The present invention also includes a data storage system having a drive controller, a plurality of disk drives coupled to and managed by the drive controller and a storage controller to which the drive controller is coupled. The storage controller includes a host adapter through which a host device transmits/receives instructions and data to/from the storage controller, a processor and a configuration table accessible to the processor. The processor is programmed for receiving disk configuration instructions, merging available storage space on the plurality of disk drives into a single virtual address space, dividing the merged storage space into segments and allocating the storage segments among one or more logical storage devices in accordance with configuration instructions stored in the configuration table and mapping the segment to physical locations by the drive controller.

### BRIEF DESCRIPTION OF THE DRAWINGS

FIG. 1 illustrates a RAID system in which data is replicated using a PPRC operation;

FIG. 2 is a block diagram of a storage system of the present invention:

FIG. 3 illustrates a segment pool into which storage space of some or all of the drives is merged; and

FIG. 4 illustrates hard drives within the storage loops of the system of FIG. 2.

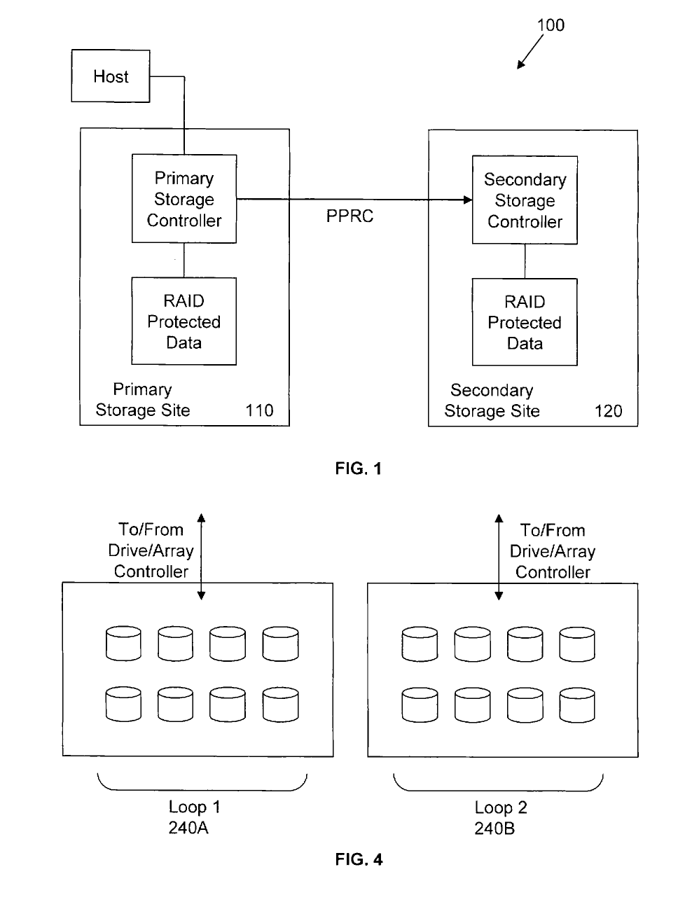

### DETAILED DESCRIPTION OF THE PREFERRED EMBODIMENT

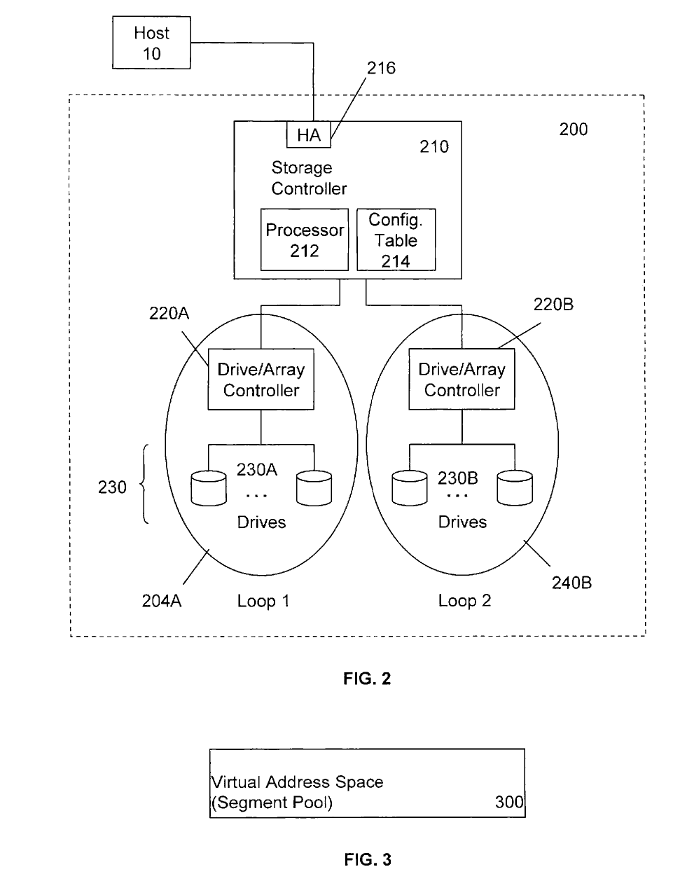

FIG. 2 is a block diagram of a storage system 200 of the present invention. The system 200 includes a storage controller 210, one or more drive controllers 220A, 220B and an equal number of drive arrays 230A, 230B (collectively referred to as 230). One pair of a drive/array controller 220A and a drive array (having multiple disk drives) 230A form a first storage loop 240A while another pair of a drive/array controller 220B and a drive array (also having multiple disk drives) 230B form a second storage loop 240B. Two drive controllers, two drive arrays and two loops are illustrated by way of an example and not by way of a limitation. The storage controller 210 includes a processor 212 and a memory in which a configuration table 214 is stored, as described hereinbelow. A host system 10 connects to the storage controller 210 through a host interface (HA) 216 and communicates with the storage controller 210 using a storage protocol. The protocol allows data to be stored and retrieved and the storage controller 210 ensures that the correct data is sent and received. The storage controller 210 manages logical devices and makes them visible to the host system 10 through the protocol.

At this point, the disk drives within the drive arrays 220A, 220B have not been configured for any particular RAID level or non-RAID arrangement. They merely represent raw storage space having a total of X Gigabytes. As illustrated in FIG. 3, in accordance with the present invention, all of the physical space 300 on the disk drives 230 is merged into a single virtual address space. The storage controller 210 receives configuration instructions and the merged space 300 is divided into segments, preferably but not necessarily of equal size, with each controller loop having a number of segments dependent on the amount of physical storage space available on the loop being divided. This is based on the size of the drives and formatting of the drives for the controller loop, wherein larger drives result in more segments being available for a given loop. The merged space 300 may be thought of as a segment pool. Thus, for example, the virtual space 300 may be divided into four segments with two segments being allocated to each of the two loops 204A, 204B. A logical storage subsystem (LSS) or device or disk array may then be created, as illustrated in FIG. 4 and represented in TABLE I.

TABLE I

| | | |
|---|---|---|
| LSS 1/Device 1 | Segments 1-2 | Loop 1 |
| | Segments 1-2 | Loop 2 |

Logical devices managed by the storage controller 210 comprise segments from the pool 300 of available segments taken from the continuous address space described previously. Users may specify the size of a desired logical device and the storage controller 210 will allocate the number of segments required to match the size specified. The storage controller 210 also allows the user to specify the level of protection afforded the data stored by host system 10. The size of the address space available for allocation will depend on the organization of the logical disk arrays that make up the storage system: JBOD, RAID 5 or other. Using the letter ‘k’ to specify the minimum level of protection given to data stored on the storage system 200, k=1 indicates that there is no specific protection beyond storage of the data on the system 200. At this level, data loss is possible if the drive on which the data is stored fails. K=2 indicates that two copies of data will be resident on the storage system 200. The storage controller 210, having previously split the contiguous address space under its management into segments allocates k segments per required segment to the logical device. This algorithm allows the data to be stored by the host 10 at a level of duplication equivalent to a minimum of k, with higher levels possible. For example, in a system with logical disk arrays formatted as RAID 5 and k=2, protection is provided which is equivalent to a storage controller system using RAID 10. When the arrays are configured as JBOD and k=2, protection is provided which is equivalent to RAID 0, or mirroring. The locations of the segments allocated are flexible, but preferably are physically separated to independent physical resources, such as on separate storage loops to which logical devices are assigned.

TABLE II illustrates a user-designated configuration of one logical device (such as a disk array) having two segments with a protection level of 3 (that is, a copy of the data on each of three loops). Segments may be similarly allocated to additional logical devices as indicated by the ellipses. It will be appreciated that more than two segments may be allocated to each device and that higher levels of protection (k>3) may be designated.

TABLE II

| | | |
|---|---|---|
| LSS 1/Device 1 | Segments 1-2 | Loop 1 |
| | Segments 1-2 | Loop 2 |
| | Segments 1-2 | Loop 3 |
| . . . | | |

The configuration table 214 is populated with the identity of the logical device(s), the number of segments allocated to each and the physical location of each segment on a disk drive 230. When the system 200 is in normal operation, the host 10 transmits data to the storage controller 210 which then directs that the data be stored to the logical device. In the example of FIGS. 2 and 4, two copies of the data are kept.

The instructions received by the storage controller 210 may include instructions for configuring the virtual space 300 as a RAID array or as just a bunch of disks (JBOD). If the virtual space 300 is to be configured as JBOD, the instructions received by the storage controller 210 may include the number of copies the user wants to keep. If the virtual space 300 is to be configured as a RAID array, the instructions will include the RAID level. Moreover, because the present invention, is not constrained by the limitations of hardware RAID, the virtual space 300 may be configured as multiple RAID arrays having the same or different levels and the space allocated to a logical device need not be contiguous. Additionally, unlike hardware RAID, the system of the present invention does not require that copies of data be stored in the same corresponding logical locations on two arrays; the copies may be anywhere. Nor is it necessary that all of the physical storage space be used.

The system of the present invention provides a user with the ability to easily tailor the system to the user's needs, even as those needs change. For example, a user may want only a single copy of data, such as for a temporary dataset for data mining, and not want the overhead required by redundancy. If a disk fails, the dataset may be lost but the job may be re-run and the dataset recreated. On the other hand, a user may the security of mirroring provided by a RAID 10 system in which case the storage controller may be instructed to configure the storage space as two RAID 5 arrays. Of course, as the user's needs change, the configuration may be changed. Consequently, a user's hardware resources may be used more efficiently and in a way to better meet the user's needs.

The algorithm of the present invention allows several benefits over previous methods of data protection. There is complete flexibility as to where the data is located on the system and the algorithm may be optimized within the system to achieve performance improvements. In addition, the disk controllers may be simplified as the storage controller now manages more of the complexity associated with data protection, a function previously pushed onto expensive to design and build disk controllers.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for method of managing a data storage system or a method for deploying computing infrastructure comprising integrating computer readable code into a computing system for method of managing a data storage system.

What is claimed is:

1. A method of managing a data storage system, comprising:
programming a storage controller with a disk configuration for each of one or more logical disk arrays and a level of protection k;
merging available storage space from one or more disk drives in the data storage system into a single virtual address space;
dividing the merged storage space into storage segments;
allocating the storage segments among the logical disk arrays;
generating a configuration table indicating the number of storage segments in each logical disk array and the physical location of each storage segment on a disk drive;
storing the configuration table in the storage controller; and
storing k copies of data on the logical disk arrays.

2. The method of claim 1, wherein programming the storage controller comprises establishing at least one RAID level.

3. The method of claim 1, wherein programming the storage controller comprises:
establishing at least one storage loop; and
assigning each logical disk array to one of the storage loops.

4. The method of claim 1, wherein allocating the storage segments comprises configuring the one or more logical disk arrays as non-RAID arrays.

5. The method of claim 1, wherein allocating the storage segments among the logical disk arrays comprises allocating fewer than all of the storage segments.

6. A data storage system, comprising:
a drive controller;
a plurality of disk drives coupled to and managed by the drive controller; and
a storage controller to which the drive controller is coupled, comprising:
a host adapter through which a host device transmits/receives instructions and data to/from the storage controller;
a processor; and
a configuration table accessible to the processor;
the processor being programmed for:
receiving disk configuration instructions, including a level of protection k;
merging available storage space on the plurality of disk drives into a single virtual address space;
dividing the merged storage space into storage segments;
allocating the storage segments among one or more logical disk arrays in accordance with the configuration instructions;
entering into the configuration table the number of storage segments in each logical disk array and the physical location of each storage segment on the disk drives; and
directing that k copies of data be stored on the logical disk arrays.

7. The data storage system of claim 6, wherein:
the configuration instructions include at least one assigned RAID level; and
the logical disk arrays are configured as a RAID array in accordance with the at least one assigned RAID level.

8. The data storage system of claim 6, wherein:
the configuration instructions include at least one storage loop; and
each logical disk array is assigned to one of the storage loops.

9. The data storage system of claim 6, wherein:
the configuration instructions include a non-RAID configuration; and
the logical disk arrays are configured as a just a bunch of disks in accordance with the non-RAID configuration.

10. The data storage system of claim 6, wherein the logical disk arrays comprise fewer than all of the storage segments.

11. A computer program product of a computer readable medium usable with a programmable computer, the computer program product having computer-readable code embodied therein for managing a data storage system, the computer-readable code comprising instructions for:
programming a storage controller with a disk configuration for each of one or more logical disk arrays and a level of protection k;
merging available storage space from one or more disk drives in the data storage system into a single virtual address space;
dividing the merged storage space into storage segments;
allocating the storage segments among the logical disk arrays;
generating a configuration table indicating the number of storage segments in each logical disk array and the physical location of each storage segment on a disk drive;
storing the configuration table in the storage controller; and
storing k copies of data on the logical disk arrays.

12. The computer program product of claim 11, wherein the instructions for programming the storage controller comprise instructions for establishing at least one RAID level.

13. The computer program product of claim 11, wherein the instructions for programming the storage controller further comprise instructions for:
establishing at least one storage loop; and
assigning each logical disk array to one of the storage loops.

14. The computer program product of claim 11, wherein the instructions for allocating the storage segments comprise instructions for configuring the one or more logical disk arrays as non-RAID arrays.

15. The computer program product of claim 11, wherein the instructions for allocating the storage segments among the logical disk arrays comprise instructions for allocating fewer than all of the storage segments.

16. A method for deploying computing infrastructure, comprising integrating computer readable code into a computing system, wherein the code, in combination with the computing system, is capable of performing the following:
programming a storage controller with a disk configuration for each of one or more logical disk arrays and a level of protection k;
merging available storage space from one or more disk drives in the data storage system into a single virtual address space;
dividing the merged storage space into storage segments;
allocating the storage segments among the logical disk arrays;
generating a configuration table indicating the number of storage segments in each logical disk array and the physical location of each storage segment on a disk drive;
storing the configuration table in the storage controller; and
storing k copies of data on the logical disk arrays.

17. The method of claim 16, wherein programming the storage controller comprises establishing at least one RAID level.

18. The method of claim 16, wherein programming the storage controller comprises:
establishing at least one storage loop; and
assigning each logical disk array to one of the storage loops.

19. The method of claim 16, wherein allocating the storage segments comprises configuring the one or more logical disk arrays as non-RAID arrays.

20. The method of claim 16, wherein allocating the storage segments among the logical disk arrays comprises allocating fewer than all of the storage segments.
